(19) United States
(12) Patent Application Publication
(10) Pub. No.: US 2004/0026598 A1
(43) Pub. Date: Feb. 12, 2004

(54) Adjustable support leg for semiconductor device manufacturing equipment

(75) Inventor: Ronald Vern Schauer, Gilroy, CA (US)

Correspondence Address: PATENT COUNSEL, APPLIED MATERIALS, INC., Legal Affairs Department, P.O. Box 450A, Santa Clara, CA, 95052, US

(73) Assignee: Applied Materials, Inc.

(21) Appl. No.: 10/284,021

(22) Filed: Oct. 30, 2002

Related U.S. Application Data
(63) Continuation-in-part of application No. 10/214,878, filed on Aug. 8, 2002.

(51) Int. Cl. F16M 11/24; F16M 3/00

(52) U.S. Cl. 248/676; 248/188.4

(57) ABSTRACT

A support pedestal for semiconductor device manufacturing equipment includes adjustable support legs. In a first aspect, each adjustable support leg includes a pair of telescopingly disposed support cylinders. The cylinders have respective threaded regions whereby the cylinders are threadingly coupled to each other. The height of each support leg is adjusted by rotation of one or both of the cylinders. Numerous other aspects are provided.

This application is a continuation-in-part of U.S. patent application Ser. No. 10/214,878, filed Aug. 8, 2002, titled “ADJUSTABLE SUPPORT LEG FOR SEMICONDUCTOR DEVICE MANUFACTURING EQUIPMENT” which is hereby incorporated by reference herein in its entirety.

### FIELD OF THE INVENTION

This invention relates to installation of semiconductor device manufacturing equipment at a wafer fabrication facility, and is more particularly concerned with an adjustable leg for a support pedestal on which the semiconductor device manufacturing equipment is installed.

### BACKGROUND OF THE INVENTION

Semiconductor processing equipment includes so-called “processing tools” which may be constituted by one or more processing chambers and may further comprise a transfer chamber installed in association with each processing chamber, and/or one or more load locks interfaced to the transfer chamber. Processing tools may be quite heavy, and may require special installation measures such as a separate structure to support the tool and to transfer the weight of the tool to an underlying floor (which may be a poured concrete waffle-grid floor). The equipment support structure may be separate from the building support structure, and according to one prior art practice may include a plurality of fabricated support legs which each extend up from one of the solid sections of the underlying waffle-grid floor to engage a mounting foot on the under side of the semiconductor processing equipment. The support legs may be steel jacks or concrete piers and are typically custom-fabricated for the installation of the processing tool. Consequently, fabrication of the support legs may require significant time and expense. It may also be necessary to provide cross beam members attached to the support legs to support the weight of the equipment, particularly for irregularly-shaped tools for which a given mounting foot may not align to a solid section of the underlying flooring.

As an alternative to custom-fabricated support legs, the Semiconductor Equipment Manufacturing Institute (hereinafter “SEMI”) has proposed a standard support structure to be used for all semiconductor factory locations. The proposed structure is a free-standing rectangular pedestal having a rectangular base with a plurality of support legs positioned so as to evenly transmit the suspended weight of the processing tool to the underlying floor structures. The legs of the SEMI pedestal extend up from solid portions of the waffle-grid floor at a level below the manufacturing level flooring (or “raised flooring”), to support the rectangular base at the manufacturing level. The processing tool is supported by cross beams and cantilevers which attach to the rectangular base. As necessary, additional customized support legs may also be required when installing processing tools on the SEMI pedestal.

One advantage of the proposed SEMI pedestal is that the pedestal may be of a standard size, thereby providing a reference size for architects and those who construct fabrication facilities. A disadvantage of the proposed SEMI pedestal includes customization necessary to ensure adequate support of irregularly-shaped processing tools, which may be neither rectangular nor of a scale to fit the standard pedestal frame.

U.S. patent application Ser. No. 09/706,435, filed Nov. 3, 2000 and titled “Installation Docking Pedestal for Pre-facilitation of Wafer Fabrication Equipment” (hereinafter “the '435 patent application”) discloses another alternative to the conventional fabrication tool support structure. The '435 patent application is hereby incorporated by reference herein in its entirety. The support structure disclosed in the '435 patent application includes a support pedestal constituted by a frame having a profile that duplicates the bottom outline of the processing tool. The frame is supported on support legs that are aligned with the load-bearing mounting feet on the bottom of the processing tool. The support legs are adjustable in length, so that the processing tool may be leveled and supported at a desired elevation above the waffle-grid floor.

The semiconductor device manufacturing equipment support arrangement of the '435 patent application represents an advance over conventional arrangements. Even so, the present inventor has recognized the desirability of providing improved adjustable support legs for supporting semiconductor device manufacturing processing tools with or without a pedestal.

### SUMMARY OF THE INVENTION

According to a first aspect of the invention, an adjustable support leg adapted to support semiconductor device manufacturing equipment is provided. The inventive adjustable support leg includes a lower support that has a first end and a second end. The lower support also has an exterior threaded region. The adjustable support leg further includes a lower plate coupled to the first end of the lower support. The inventive adjustable support leg also includes an upper support having a first end and a second end. The upper support also has an inner threaded region threadingly coupled to the exterior threaded region of the lower support so that the upper support raises relative to the lower support as the upper support is rotated in a first direction and lowers relative to the lower support as the upper support is rotated in a second direction opposite the first direction. The inventive adjustable support leg also includes an upper plate coupled to the second end of the upper support. The lower support and the upper support are configured to support semiconductor device manufacturing equipment.

According to a second aspect of the invention, another embodiment of the adjustable support leg is provided. The adjustable support leg according to the second aspect of the invention includes an upper support which has a first end and a second end. The upper support also has an exterior threaded region. The adjustable support leg of the second aspect of the invention also includes an upper plate coupled to the first end of the upper support. The adjustable support leg of the second aspect of the invention further includes a lower support having a first end and a second end, and a lower plate coupled to the second end of the lower support. The lower support also has an inner threaded region threadingly coupled to the exterior threaded region of the lower support so that the upper support raises relative to the lower support as the upper support is rotated in a first direction and lowers relative to the lower support as the upper support is rotated in a second direction opposite the first direction. The lower support and the upper support are configured to support semiconductor device manufacturing equipment.

According to a third aspect of the invention, yet another embodiment of the adjustable support leg is provided. The adjustable support leg according to the third aspect of the invention includes (1) a lower support section; and (2) an upper support section adapted to telescopingly couple with the lower support section. The lower and upper support sections are threadingly engaged with each other. Also, the lower and upper support sections have dimensions sufficient to provide vertical and lateral support and an extent of threaded engagement of the lower and upper support sections includes a number and a dimension of threads sufficient to withstand a shear force generated when the adjustable support leg is employed to support semiconductor device manufacturing equipment. Numerous other aspects are provided, as are systems and methods in accordance with these and other aspects of the invention.

In further aspects, the upper and/or lower plate may be omitted, or may be coupled to the upper and/or lower supports so as to allow rotation between the support and the plate yet so as to constrain the support vertically and horizontally (i.e., may be rotatably coupled).

As used herein the “combined length of the lower and upper supports” will be understood to mean the distance between the lower surface of the upper plate and the upper surface of the lower plate.

The methods and apparatus of the present invention provide for an adjustable support leg of a support pedestal for semiconductor device manufacturing equipment such that the adjustable support leg is simpler in design and of lower cost than previously proposed adjustable support legs.

Other features and advantages of the present invention will become more fully apparent from the following detailed description, the appended claims and the accompanying drawings.

### BRIEF DESCRIPTION OF THE DRAWINGS

FIG. 1 is a schematic top perspective view of a support pedestal provided in accordance with the invention and shown in juxtaposition with a schematically-represented bottom outline of semiconductor device manufacturing equipment to be supported on the support pedestal;

FIG. 2 is a schematic vertical cross-sectional view of an adjustable support leg provided in accordance with the invention;

FIG. 3 is an isometric view showing a lower portion of the adjustable support leg of FIG. 2;

FIG. 4 is an isometric view showing an upper portion of the adjustable support leg of FIG. 2; and

FIG. 5 is a schematic vertical cross-sectional view of an alternative embodiment of the adjustable support leg.

### DETAILED DESCRIPTION

According to the invention, an adjustable support leg (which may also be referred to as a “pedestal leg”) includes two telescoping supports that are threadingly engaged. The overall height of the pedestal leg may be adjusted by rotating at least one of the supports so as to adjust the amount of overlap between the two supports. A stable, low-cost, infinitely adjustable support leg may thereby be provided. The pedestal leg is infinitely adjustable in that, within the accommodatable height range of the pedestal leg, any pedestal height may be assumed through appropriate rotation of at least one of the two supports (as described further below).

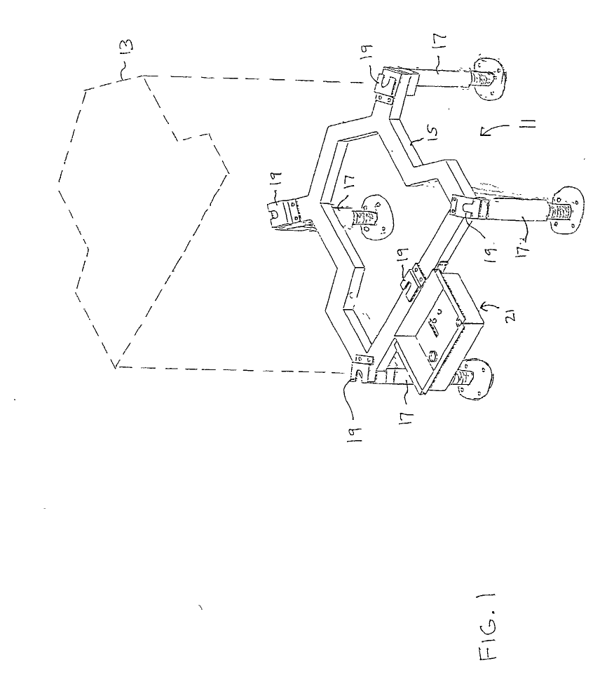

FIG. 1 is a schematic top perspective view of an inventive support pedestal 11, in juxtaposition with a bottom outline (represented by dashed lines 13) of semiconductor device manufacturing equipment to be supported on the support pedestal 11. The inventive support pedestal 11 includes a support frame 15 having a plurality of adjustable support legs 17 extending downward therefrom. The adjustable support legs 17 are provided in accordance with the invention and are described in more detail below.

The support frame 15 has a frame outline which substantially duplicates the bottom outline 13 of the semiconductor device manufacturing equipment to be supported on the support pedestal 11. In one aspect, the support frame 15 may be monolithic so as to provide the enhanced support integrity which comes from a “seamless” frame. The support frame 15 includes brackets 19 for engaging the load-bearing mounting feet (if any) of the semiconductor device manufacturing equipment. The inventive support pedestal 11 may also include at least one facilities connection locator 21 which is fixedly mounted to the support frame 15 and which establishes facilities connection locations which exactly match the facilities connection points on the semiconductor device manufacturing equipment to be supported on the support pedestal 11.

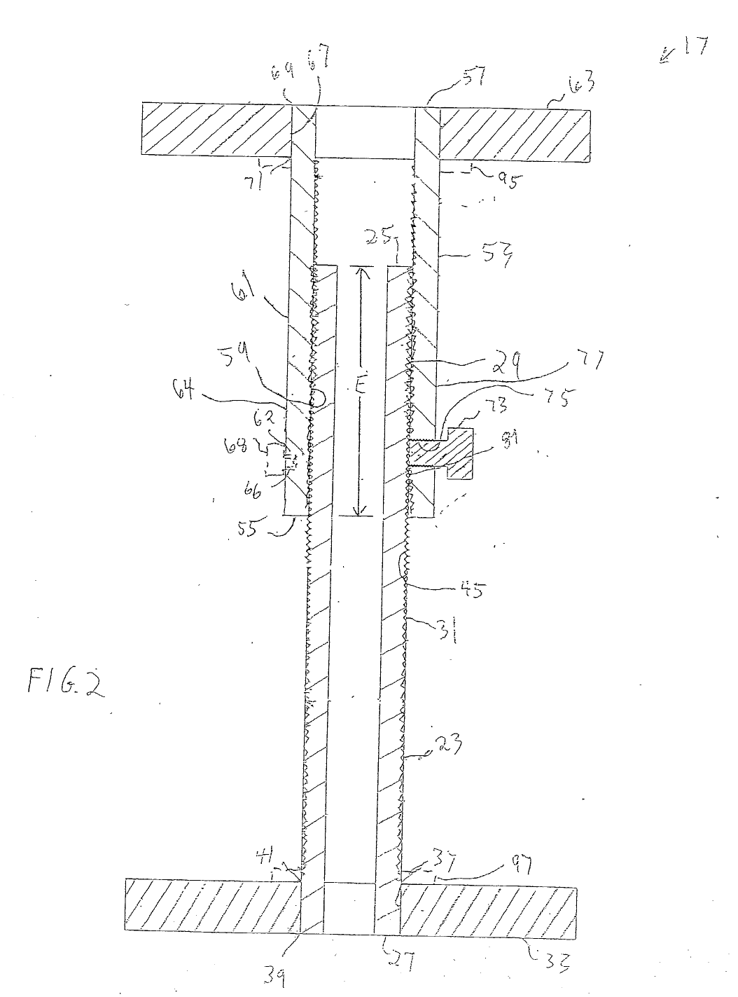

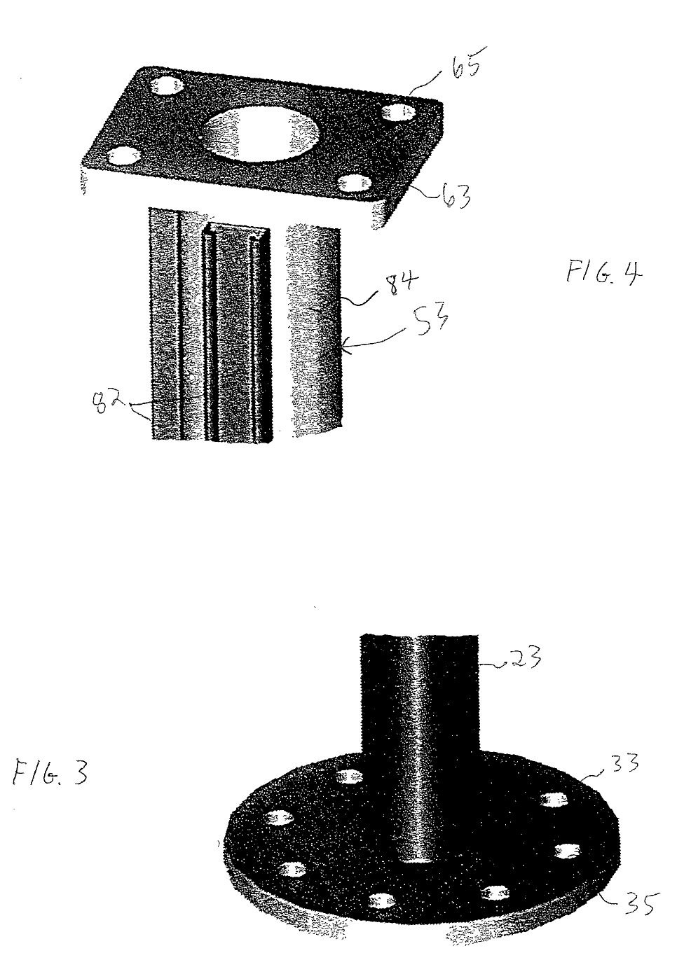

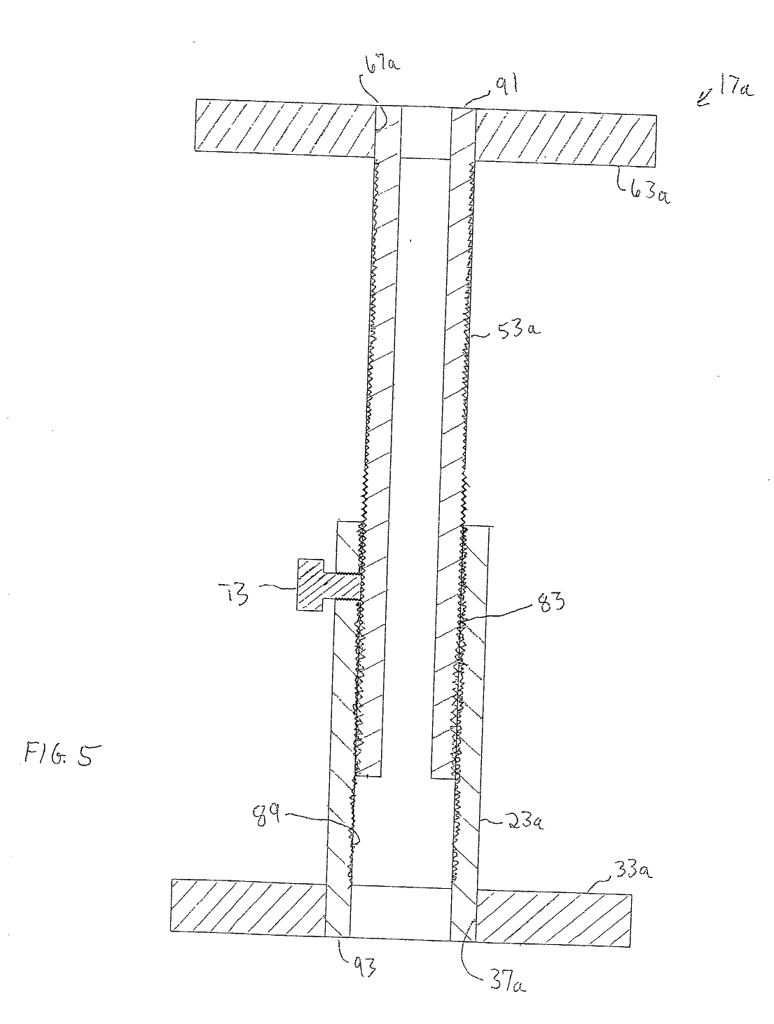

A first embodiment of the adjustable support leg 17 will now be described with reference to FIGS. 2-4. FIG. 2 is a somewhat schematic vertical cross-sectional view of the inventive adjustable support leg 17. FIG. 3 is an isometric view showing a lower portion of the inventive adjustable support leg 17, and FIG. 4 is an isometric view showing an upper portion of the inventive adjustable support leg 17.

The inventive adjustable support leg 17 includes a lower support (e.g., a lower support cylinder 23 in the preferred embodiment described herein) which has an upper end 25 (FIG. 2) and a lower end 27. The lower support cylinder 23 also has an exterior threaded region 29 which may extend from a central portion 31 of the lower support cylinder 23 to the upper end 25 of the lower support cylinder 23. In general, the threaded region 29 may extend any distance from the upper end 25 toward the lower end 27, and may even extend all the way to the lower end 27 (as shown in FIG. 2), in order to maximize the range of adjustable heights available. In alternative aspects, the exterior threaded portion may extend along any portion of the support cylinder, including, for example, only a lower or central region of the support cylinder. As will be described below, a length L of the threaded region 29 sets the maximum distance over which the support leg 17 may be adjusted. In at least one embodiment, the length L of the threaded region 29 is about twenty-two inches, although other lengths may be employed.

A lower plate 33 may be fixedly coupled to the lower end 27 of the lower support cylinder 23. As seen from FIG. 3, the lower plate 33 may have a circular profile. Other shapes of the lower plate 33 are also contemplated. Mounting holes 35 (e.g., eight mounting holes in the embodiment shown, although other numbers may be employed) are formed in the lower plate 33 and may be employed to secure the lower plate 33 to the waffle-grid floor of a fabrication facility or the like. According to an aspect of the invention, the lower plate 33 may have a central aperture 37 (FIG. 2) through which the lower end 27 of the lower support cylinder 23 extends. By this arrangement, the lower support cylinder 23 may be secured to the lower plate 33 by welding at both the lower surface of the lower plate 33 (as indicated at 39) and at the upper surface of the lower plate 33 (as indicated at 41). It is alternatively contemplated that the lower support cylinder 23 be welded to the lower plate 33 only at the upper surface or only at the lower surface of the lower plate 33. As another alternative, the central aperture 37 may be omitted, and the lower end 27 of the lower support cylinder 23 may abut the upper surface of the lower plate 33 and be welded thereto. It is also contemplated to secure the lower support cylinder 23 to the lower plate 33 by bolting or other fastening means. If the lower support cylinder 23 is secured to the lower plate 33 by welding to both the top and bottom surfaces of the lower plate 33, the inventive adjustable support leg 17 may have superior strength (e.g., the support leg 17′s load capacity may be doubled as compared to a support leg 17 having a welded connection to only the top surface of the lower plate 33) and the need for welding inspections may be reduced. Also, because the support cylinder extends through the plate rather than merely abutting the plate, the load experienced by the cylinder is transferred directly to the surface to which the plate is coupled (e.g., the subfloor, or the pedestal frame). Because the welds are at two different locations along the axis of the support cylinder, they tightly constrain the support cylinder, In one aspect the welds are flush fillet welds although other types of welds, such as flare, bevel, flange or groove, etc., may be employed.

The inventive adjustable support leg 17 also includes an upper support (e.g., an upper support cylinder 53 in the preferred embodiment described herein) which has a lower end 55 and an upper end 57. The upper support cylinder 53 also has an inner threaded region 59 which may extend from a central portion 61 of the upper support cylinder 53 to the lower end 55 of the upper support cylinder 53. In general, the threaded region 59 may extend any distance from the lower end 55 toward the upper end 57, and may even extend all the way to the upper end 57 (as shown in FIG. 2), in order to maximize the range of adjustable heights available. In alternative aspects, the threaded region 59 may extend along any portion of the upper support cylinder 53, including, for example, only an upper or central region of the upper support cylinder 53.

As shown in FIG. 2, the exterior threaded region 29 of the lower support cylinder 23 is threadingly engaged with the inner threaded region 59 of the upper support cylinder 53. Rotation of the upper support cylinder 53 around its longitudinal axis in one direction causes the upper support cylinder 53 to be raised with respect to the lower support cylinder 23, and rotation of the upper support cylinder around its longitudinal axis in an opposite direction causes the upper support cylinder 53 to be lowered with respect to the lower support cylinder 23, thereby (in either case) changing the combined length of the lower support cylinder 23 and the upper support cylinder 53, and adjusting the height of the inventive adjustable support leg 17. As used herein and in the appended claims, the “combined length of the lower and upper support cylinders” will be understood to mean the distance between the lower surface of the upper plate and the upper surface of the lower plate. It will be appreciated that instead of or in addition to rotating the upper support cylinder 53 to adjust the height of the inventive adjustable support leg 17, the lower support cylinder 23 may be rotated.

Rotation of one or both of the support cylinders 23, 53 may be accomplished or facilitated by use of a suitable wrench. For example, one or more engagement holes 62 (FIG. 2, of which only one is shown, in phantom) or similar engagement features may be formed in an outer surface 64 of the upper support cylinder 53 (and/or in an outer surface of the lower support cylinder 23 particularly in the embodiment of FIG. 5). The engagement hole or holes 62 may be adapted to be engaged by a suitable feature 66 of, for example, a “spanner”-type wrench schematically-indicated at 68. Other types of wrench arrangements that may be employed are described in co-pending commonly-assigned U.S. patent application Ser. No. 10/214,878, filed Aug. 8, 2002, and entitled “Adjustable Support Leg for Semiconductor Device Manufacturing Equipment Support Pedestal” (AMAT docket no. 7242), which is incorporated herein by reference.

An upper plate 63 may be fixedly coupled to the upper end 57 of the upper support cylinder 53. As seen in FIG. 4, the upper plate 63 may have a generally rectangular profile, in accordance with conventional practices for top mounting plates of semiconductor device manufacturing equipment support legs. The upper plate 63 may have a plurality of mounting holes 65 (e.g., four mounting holes in the embodiment shown, although other numbers may be employed) by which the upper plate 63 may be secured to the support frame 15 (FIG. 1) of the support pedestal 11, or to semiconductor device manufacturing equipment (or mountings thereof) in the event a support pedestal is not employed.

Referring again to FIG. 2, the upper plate 63 may also have a central aperture 67 formed therein. The central aperture 67 is sized to allow the upper end 57 of the upper support cylinder 53 to extend partially or entirely therethrough, allowing the upper support cylinder 53 to be secured to the upper plate 63 by welding at the lower surface of the upper plate 63 (as indicated at 71) and optionally at the upper surface of the upper plate 63 (as indicated at 69). It is also contemplated to weld the upper support cylinder 53 to the upper plate 63 only at location 69 or only at location 71. Alternatively, the central aperture 67 may be omitted, such that the upper end 57 of the upper support cylinder 53 abuts the lower surface of the upper plate 63 and is welded only at the lower surface of the upper plate 63. As another alternative, the upper support cylinder 53 may be secured to the upper plate 63 by bolting or other fastening means. If the upper support cylinder 53 is secured to the upper plate 63 by welding at both the top and bottom surfaces of the upper plate 63, the inventive adjustable leg 17 may have superior strength and the need for welding inspections may be reduced (as described previously with reference to the lower plate 33).

The materials and dimensions of the lower and upper plates 33 and 63 and of the lower and upper support cylinders 23 and 53 all may be selected so that the inventive adjustable support leg 17 is suitable for supporting heavy semiconductor device manufacturing equipment. Also, the lower and upper support cylinders may be threadingly engaged with each other in a manner that is suitable for supporting heavy semiconductor device manufacturing equipment. For example, a distance along the support cylinders in which threaded engagement is in place (referred to as an engaged portion and indicated by dimension E in FIG. 2) may be arranged so as to be suitable for supporting heavy semiconductor device manufacturing equipment. It will be understood that the threaded engagement of the upper and lower support cylinders is also selected to provide a desired height of the adjustable support leg 17.

The lower support cylinder 23 may, for example, have an inner diameter of about 2 inches and a wall thickness of about 1/2 inch. The upper support cylinder 53 may, for example, have an outer diameter of about 4 inches and a wall thickness of about 1/2 inch. The respective lengths of the support cylinders may, for example, be in the range of about 20 inches to about 25 inches. The support cylinders need not be equal in length. The support cylinders may be formed of structural steel tubing, for example. The lower plate 33 may be formed from the structural steel plate and may have a diameter of about 10 inches and a thickness of about 1/2 inch. The upper plate may be formed from structural steel plate and may have a length of about 8 inches, a width of about 6 inches and a thickness of about 1/4 inch. Other dimensions and/or materials may be employed for one or more of these components.

In at least one embodiment, the dimensions and materials of the lower and upper support cylinders 23, 53 and of the lower and upper plates 33, 63 are selected to provide adequate vertical and lateral support for the particular semiconductor device manufacturing equipment to be supported by the support leg 17. The maximum distance over which the support leg 17 may be adjusted may be determined by one or more of the lengths of the threaded regions 24, 59 and the lengths of the support cylinders 23, 53.

Note that unlike conventional adjustable support legs that employ a pin that slides through both upper and lower supports to position the upper support relative to the lower support the threaded engagement of the upper and lower support cylinders allows for infinite adjustment of the overall height of the adjustable support leg 17 over the range of adjustment of the adjustable support leg.

As will be appreciated by those who are skilled in the art, when the support leg 17 is installed in place supporting semiconductor device manufacturing equipment, the threadingly engaged arrangement of the upper and lower support cylinders tends to be inherently self-locking. However, if it is desired to further assure secure locking of the upper support cylinder 53 and the lower support cylinder 23 relative to each other, a locking pin 73 may be provided. For example, a threaded hole 75 may be provided in a wall 77 of the upper support cylinder 53 to threadingly receive the locking pin 73, as shown in FIG. 2. Alternatively, a nut (not shown) may be mounted externally of the upper support cylinder 53 to threadingly receive the locking pin 73. The locking pin 73 may be threadingly tightened to abut an outer surface 81 of the lower support cylinder 23, as shown in FIG. 2. Alternatively, a hole (not shown) may be drilled in the lower support cylinder 23, along the path defined by the hole 75 in the upper support cylinder 53, and the locking pin 73 may be inserted in the hole in the lower support cylinder 23 to provide positive locking of the lower support cylinder 23 and the upper support cylinder 53.

An additional or alternative locking mechanism may be provided by cutting a horizontal groove (not shown) into and through the upper support cylinder 53 near the lower end 55 of the upper support cylinder 53 and tightening one or more bolts (not shown) vertically disposed at the lower end 55 to collapse the lowest few threads of the threaded region 59 of the upper support cylinder 53 against the threaded region 29 of the lower support cylinder 23. The locking together of the threaded regions in this manner may be reversible by loosening the one or more bolts.

Referring to FIG. 4, one or more attachment mechanisms such as channeled attachment rails 82 may be mounted on an outer surface 84 of the upper support cylinder 53. In the particular embodiment illustrated in FIG. 4, at least two attachment rails 82 are mounted at respective points around the circumference of the upper support cylinder 53. The attachment rails 82 may be, for example, of the type marketed under the trademark “Unistrut™” by Tyco International, Ltd. As will be recognized by those who are skilled in the art, the attachment rails 82 may be provided to support, e.g., electrical trays or boxes, piping hangers, tools, etc. Other numbers and types of, and placement locations for, the attachment mechanisms may be employed.

According to another embodiment of the inventive adjustable support leg, the adjustment arrangement shown in FIG. 2 may be essentially inverted. A modified adjustable support leg 17a, provided in accordance with this alternative embodiment of the invention, is illustrated in FIG. 5. The adjustable support leg 17a includes an upper support (e.g., upper support cylinder 53a) which has an exterior threaded region 83. In order to maximize the range of adjustable heights, the threaded region 83 may extend along the entire length of the upper cylinder. In alternative aspects, the exterior threaded portion may extend along any portion of the support cylinder, including for example, only a lower, upper or central region of the support cylinder. The adjustable support leg 17a also includes a lower support cylinder 23a which has an inner threaded region 89 that is threadingly engaged with the exterior threaded region 83 of the upper support cylinder 53a. The inner threaded region 89 of the lower support cylinder 23a may extend along the entire length of the lower support cylinder 23a (as shown in FIG. 5), or may extend along any lower, upper or central portion of the lower support cylinder.

An upper end 91 of the upper support cylinder 53a may be fixedly coupled to an upper plate 63a. A central aperture 67a of the upper plate 63a may have a smaller diameter than the central aperture 67 of the upper plate 63 of the embodiment of FIG. 2, in view of the upper support cylinder 53a having a smaller outer diameter than the upper cylinder 53 of the embodiment of FIG. 2. A lower end 93 of the lower support cylinder 23a may be fixedly coupled to a lower plate 33a. The lower plate 33a has a central aperture 37a which may have a larger diameter than the central aperture 37 of the lower plate 33 of the embodiment of FIG. 2, in view of the lower support cylinder 23a having a larger outer diameter than the lower support cylinder 23 of the embodiment of FIG. 2. Dimensions and/or materials of components of the adjustable support leg 17a may be selected based on considerations similar to those employed for the adjustable support leg 17.

As in the embodiment of FIG. 2, one or both of the upper and lower support cylinders may be rotated about the longitudinal axis thereof (e.g., by a wrench, which is not shown in FIG. 5) to adjust the combined length of the upper and lower support cylinders 23a, 53a, thereby adjusting the height of the adjustable support leg 17a.

During assembly and/or installation of the inventive adjustable support leg 17, the following procedure may be followed (a similar or identical procedure may be employed for the adjustable support leg 17a):

(a) The lower support cylinder 23 is secured to the lower plate 33 (e.g., by welding);

(b) The upper support cylinder 53 is threadingly engaged with the lower support cylinder;

(c) The upper support cylinder 53 is rotated (e.g., by means of the wrench 68) to adjust the combined length of the lower and upper support cylinders 23, 53, thereby adjusting the height of the adjustable support leg 17;

(d) The lower plate 33 is appropriately secured (e.g., secured to waffle-grid flooring by bolting via at least some of the mounting holes 35);

(e) The upper plate 63 if secured to the upper support cylinder 53 (e.g., by welding).

(f) The support frame 15 is supported on the upper plate 63 (e.g., the support frame 15 is bolted to the upper plate 63 via the mounting holes 65); and

(g) Semiconductor device manufacturing equipment is supported on the support frame 15 (e.g., by securing mounting feet of the semiconductor device manufacturing equipment to the support frame 15 at each point on the support frame 15 at which the support frame 15 is secured to an adjustable support leg 17).

Alternatively the support frame 15 may be omitted, and the upper mounting plate 63 coupled directly to the semiconductor device manufacturing equipment (or mounting feet thereof) in the event a support pedestal is not employed.

It will be appreciated that there may be many variations in the above procedure including variations in the order of performing the steps. According to one variation the upper plate 63 may be provided initially without holes, and may be of circular profile, and may be secured to the upper support cylinder 53 prior to adjustment in height of the support leg 17. Holes may be drilled in the upper plate 63 after adjustment in height of the support leg 17 in positions suitable to facilitate attachment of the support frame 15 to the upper plate 63.

The adjustable support leg provided in accordance with the invention may have fewer component parts than previously proposed adjustable support legs, thereby reducing manufacturing cost. In addition, there may be few, if any, dimensionally-critical component parts, which also provides savings in manufacturing costs. Furthermore, the upper and lower support cylinders of the inventive adjustable support leg may be obtained more readily and at lower cost than previously proposed support members having, for example, a rectangular profile. Furthermore, the support cylinders of the inventive adjustable support leg may be obtained in a “seamless” form, without internal welds or protrusions, so that the support cylinders may have superior strength. Moreover, the support cylinders can be fitted to each other without machining or other adaptations, such as shims, thereby also reducing the manufacturing cost.

In previously proposed adjustable support legs, an outer section was locked to an inner section by crushing the outer section and forming a frictional grip. Side-clamp through bolts were provided for this purpose. With such an arrangement, it was necessary to provide internal structure, such as reinforcing tubes, to prevent the inner section from also being crushed. By contrast, in the inventive adjustable support leg, the locking of the support cylinders with respect to each other is provided inherently and/or by the locking pin an/or locking groove arrangements described above. Consequently there is no crushing of the outer support cylinder, and reinforcement or other internal structure is not required for the inner support cylinder.

Since the outer support cylinder need not be crushed to lock the two support cylinders together, the outer support cylinder may be relatively thick, thereby enhancing the strength of the inventive adjustable support leg. The strength of the adjustable support leg is further enhanced by the fact that the outer support cylinder is not deformed.

With the optional round profile of the lower plate 33, 33a, and the optional symmetrical arrangement of mounting holes 35 in the lower plate 33, 33a, there is great flexibility in aligning the mounting holes 35 with a waffle-grid floor and other potential attachment points. The lower plate design 33, 33a also promotes re-usability of the inventive adjustable support leg.

The cost of the inventive adjustable support leg may be further reduced because the design thereof does not require expensive fasteners such as high-tensile through bolts. Moreover, the machining required for fabrication of the inventive adjustable support leg is generally simple, such as lathe or screw machine work. Thus expensive and time consuming machining such as milling, laser cutting or water jet machining is not required.

Another advantage of the inventive adjustable support leg relative to previously proposed support legs having a rectangular profile is that the inventive adjustable support leg is compatible with mounting of plural attachment mechanisms such as rails 82. Moreover, the attachment rails may be mounted freely at substantially any point around the circumference of the upper support cylinder 53, 53a. By contrast, in the previous support legs having a rectangular profile, two of the four sides of the upper support member were occupied by side-clamping through bolts and a third side was occupied by an adjustment mechanism. Consequently, only one side of the upper support member was available for mounting an attachment rail.

In one aspect of the invention, the support cylinders may be fabricated from stainless steel, high chromium steel, or other non-corrosive, non-rusting materials. Thus painting and/or powder-coating of these parts may be reduced or eliminated. This in turn reduces the possibility of the paint or coatings being abraded and generating particles. The likelihood of particle contamination of a semiconductor fabrication facility therefore is reduced.

The likelihood of particle contamination is further reduced by the self-sealing nature of the junction between the upper and lower support cylinders. Given that the open ends of the support cylinders will typically be mated to flooring or the underside of the pedestal frame, or may be easily and cheaply sealed, the inventive adjustable support leg may not provide any paths for particle migration.

The design of the inventive adjustable support leg is also conducive to modular construction with enhanced adjustment range compared to previously proposed adjustable support legs. Accordingly, a relatively few varieties of inventive adjustable support legs may be capable of satisfactory use in a wide range of applications, thus reducing inventory and again saving in manufacturing cost.

The foregoing description discloses only exemplary embodiments of the invention; modifications of the above disclosed apparatus which fall within the scope of the invention will be readily apparent to those of ordinary skill in the art. For example, although one locking pin is shown in the embodiments of FIGS. 2 and 5, additional locking pins may be employed to aid in securing the upper and lower supports to each other. Alternatively the locking pin may be omitted entirely.

In the particular embodiment of the invention illustrated in FIGS. 2-4, two channeled attachment rails 82 are shown mounted on the upper support cylinder 53. Alternatively three or more attachment rails, only one attachment rail, or no attachment rails may be mounted thereon.

Similarly, although depicted in the figures as separate, the upper plate of the inventive support leg can be either separate from, or integrally formed with, the pedestal frame (as may be the upper support with or without the upper plate). The lower and/or upper supports may be integrally formed with the lower and upper plates, respectively. It is also contemplated to employ the inventive support leg without a pedestal frame, that is, directly in support of a mounting foot of semiconductor device manufacturing equipment to be supported by the adjustable support leg. It will be understood that not all manufacturing equipment employs mounting feet, and that the present invention may be employed whether or not mounting feet are present on the equipment to be supported.

Although the lower support cylinder 23 (FIG. 5) and the upper support cylinder 53a (FIG. 6) have been illustrated as hollow cylindrical bodies with external threading, either one could alternatively be provided as a solid threaded rod.

The adjustable support legs described herein may be coupled to the support frame 15 at any location. For example, the support frame 15 may be provided with a channel, a groove or other surface features that allow each support leg to be coupled to the support frame 15 at any location along the support frame 15.

Although the upper and lower mounting plates have been described as welded to the respective support, it will be apparent that any manner of fixedly coupling the supports to the mounting plates may be employed, such as gluing, bonding, taper press-fitting, threading, jam nutting, brazing, compression clamping, collar clamping, etc. Moreover, the upper and or lower mounting plates may be integrally formed with the respective upper or lower supports (e.g., via casting, etc.). Accordingly, fixedly coupled will be understood to include any of the attachment methods described above and other similar methods including integral forming.

Similarly, although the upper and lower plates are shown having particular shapes, it will be apparent that other shapes may be employed. Other shapes may include, for example, square, hexagonal, rectangular, triangular, etc. Moreover, it should be recognized that either or both of the plates may be omitted. For example, the end of the lower support may be mounted or fixedly coupled to the waffle grid floor or other underlying support structure, and the upper support may be mounted or fixedly coupled to the equipment support pedestal.

All or a portion of each of the upper and lower supports (e.g., lower and upper support cylinders 23, 53 and/or lower and upper support cylinders 23a, 53a) may be other than cylindrical. For example, in the embodiment of FIGS. 1-5, all or a portion of the upper support may have a square, triangular, or otherwise shaped exterior cross-section, as may the non-threaded portion of the lower support. Likewise, in the embodiment of FIG. 6, all or a portion of the lower support may have a square, triangular, or otherwise shaped exterior cross-section, as may the non-threaded portion of the upper support.

Finally, the upper and/or lower supports may be rotatably coupled to the respective upper or lower plate in a manner that constrains the support both vertically and horizontally, yet allows the support to rotate. Such couplings may be achieved, for example, via clamping rings, flanges or compression clamps, etc. For example, a flange 95 (FIG. 2; shown in phantom) may be provided extending outwardly from the upper support cylinder 53 near the upper end 57 of the upper support cylinder 53 to rotatable support the upper plate 63 on the upper support cylinder 53. Similarly, a flange 97 (FIG. 2, shown in phantom) may be provided extending outwardly from the lower support cylinder 23 near the lower end 27 of the lower support cylinder 23, so that the lower support cylinder 23 may be rotatably supported on the lower plate 33.

Attachment mechanisms such as the rails 82 shown in FIG. 4 could additionally or alternatively be mounted on the lower support cylinder, e.g., in the embodiment of FIG. 5. Also, one or more slits may be formed on the side of the outer tube. A clamping ring or similar feature could then be used to compress the outer tube onto the inner tube, thus rotationally locking the two tubes relative to one another. Of course, the engagement of the two tubes for support and adjustment purposes would still be via the inner/outer threaded features.

Accordingly, while the present invention has been disclosed in connection with exemplary embodiments thereof, it should be understood that other embodiments may fall within the spirit and scope of the invention, as defined by the following claims.

The invention claimed is:

1. An adjustable support leg adapted to support semiconductor device manufacturing equipment comprising:
a lower support having a first end and a second end, and having an exterior threaded region;
a lower plate coupled to the first end of the lower support;
an upper support having a first end and a second end, and having an inner threaded region threadingly coupled to the exterior threaded region of the lower support so that the upper support raises relative to the lower support as the upper support is rotated in a first direction and lowers relative to the lower support as the upper support is rotated in a second direction opposite the first direction; and
an upper plate coupled to the second end of the upper support;
wherein the lower support and the upper support are configured to support semiconductor device manufacturing equipment.

2. The adjustable support leg of claim 1 wherein the inner threaded region of the upper support and the exterior threaded region of the lower support are engaged such that an engaged portion of the threaded regions has a number and dimensions of threads sufficient to support semiconductor device manufacturing equipment.

3. The adjustable support leg of claim 1, further comprising a plurality of channeled attachment rails mounted on the upper support at respective points around a circumference of the upper support.

4. The adjustable support leg of claim 1, wherein the upper support has at least one engagement feature formed in an outer surface of the upper support and adapted to be engaged by a wrench.

5. The adjustable support leg of claim 1, wherein the lower support is coupled to the lower plate at an upper surface of the lower plate and at a lower surface of the lower plate.

6. The adjustable support leg of claim 1, wherein the upper support is coupled to the upper plate at an upper surface of the upper plate and at a lower surface of the upper plate.

7. The adjustable support leg of claim 1, further comprising a locking pin which extends through a hole in a wall of the upper support to engage the lower support.

8. The adjustable support leg of claim 1, wherein the lower plate has a circular profile.

9. An adjustable support leg adapted to support semiconductor device manufacturing equipment comprising:
an upper support having a first end and a second end, and having an exterior threaded region;
an upper plate coupled to the first end of the upper support;
a lower support having a first end and a second end and having an inner threaded region threadingly coupled to the exterior threaded region of the upper support so that the upper support raises relative to the lower support as the upper support is rotated in a first direction and lowers relative to the lower support as the upper support is rotated in a second direction opposite the first direction; and
a lower plate coupled to the second end of the lower support;
wherein the lower support and the upper support are configured to support semiconductor device manufacturing equipment.

10. The adjustable support leg of claim 9 wherein the inner threaded region of the lower support and the exterior threaded region of the upper support are engaged such that an engaged portion of the threaded regions has a number and dimensions of threads sufficient to support semiconductor device manufacturing equipment.

11. The adjustable support leg of claim 9, further comprising a plurality of channeled attachment rails mounted on the lower support at respective points around a circumference of the lower support.

12. The adjustable support leg of claim 9, wherein the lower support has at least one engagement feature formed in an outer surface of the lower support and adapted to be engaged by a wrench.

13. The adjustable support leg of claim 9, wherein the lower support is coupled to the lower plate at an upper surface of the lower plate and at a lower surface of the lower plate.

14. The adjustable support leg of claim 9, wherein the upper support is coupled to the upper plate at an upper surface of the upper plate and at a lower surface of the upper plate.

15. The adjustable support leg of claim 9, further comprising a locking pin which extends through a hole in a wall of the lower support to engage the upper support.

16. The adjustable support leg of claim 9, wherein the lower plate has a circular profile.

17. A support pedestal adapted to support semiconductor device manufacturing equipment, the support pedestal comprising:
a plurality of adjustable support legs; and
a frame supported on the plurality of adjustable support legs, the frame having a frame outline which substantially duplicates a bottom outline of the semiconductor device manufacturing equipment;
wherein each of the adjustable support legs comprises:
a lower support having a first end and a second end, and having an exterior threaded region;
a lower plate coupled to the first end of the lower support;
an upper support having a first end and a second end, and having an inner threaded region threadingly coupled to the exterior threaded region of the lower support so that the upper support raises relative to the lower support as the upper support is rotated in a first direction and lowers relative to the lower support as the upper support is rotated in a second direction opposite the first direction; and
an upper plate coupled to the second end of the upper support.

18. The support pedestal of claim 17, wherein at least one of the adjustable support legs includes a plurality of channeled attachment rails mounted on the upper support of the at least one adjustable support leg at respective points around a circumference of the upper support.

19. The support pedestal of claim 17, wherein the upper support of each adjustable support leg has at least one engagement feature formed in an outer surface of the upper support and adapted to be engaged by a wrench.

20. The support pedestal of claim 17, wherein each of the lower supports is coupled to its associated lower plate at an upper surface of the associated lower plate and at a lower surface of the associated lower plate.

21. The support pedestal of claim 17, wherein each of the upper supports is coupled to its associated upper plate at an upper surface of the associated upper plate and at a lower surface of the associated upper plate.

22. A support pedestal adapted to support semiconductor device manufacturing equipment, the support pedestal comprising:
a plurality of adjustable support legs; and
a frame supported on the plurality of adjustable support legs, the frame having a frame outline which substantially duplicates a bottom outline of the semiconductor device manufacturing equipment;
wherein each of the adjustable support legs comprises:
an upper support having a first end and a second end, and having an exterior threaded region;
an upper plate coupled to the first end of the upper support;
a lower support having a first end and a second end, and having an inner threaded region threadingly coupled to the exterior threaded region of the upper support so that the upper support raises relative to the lower support as the upper support is rotated in a first direction and lower relative to the lower support as the upper support is rotated in a second direction opposite to the first direction; and
a lower plate fixedly coupled to the second end of the lower support.

23. The support pedestal of claim 22, wherein at least one of the adjustable support legs includes a plurality of channeled attachment rails mounted on the lower support of the at least one adjustable support leg at respective points around a circumference of the lower support.

24. The support pedestal of claim 22, wherein the lower support of each adjustable support leg has at least one engagement feature formed in an outer surface of the lower support and adapted to be engaged by a wrench.

25. The support pedestal of claim 22, wherein each of the lower supports is coupled to its associated lower plate at an upper surface of the associated lower plate and at a lower surface of the associated lower plate.

26. The support pedestal of claim 22, wherein each of the upper supports is coupled to its associated upper plate at an upper surface of the associated upper plate and at a lower surface of the associated upper plate.

27. A method of installing semiconductor device manufacturing equipment, comprising:
providing an adjustable support leg comprising:
a lower support having a first end and a second end, and having an exterior threaded region;
a lower plate coupled to the first end of the lower support;
an upper support having a first end and a second end, and having an inner threaded region threadingly coupled to the exterior threaded region of the lower support so that the upper support raises relative to the lower support as the upper support is rotated in a first direction and lowers relative to the lower support as the upper support is rotated in a second direction opposite the first direction; and
an upper plate coupled to the second end of the upper support;
wherein the lower support and the upper support are configured to support semiconductor device manufacturing equipment; and
adjusting a combined length of the lower and upper supports by rotating at least one of the upper support and the lower support.

28. The method of claim 27, further comprising supporting a support frame that is shaped and sized to support semiconductor device manufacturing equipment on the upper plate.

29. The method of claim 28, further comprising supporting semiconductor device manufacturing equipment on the support frame.

30. The method of claim 29, wherein the support frame has a frame outline that substantially duplicates a bottom outline of the semiconductor device manufacturing equipment.

31. The method of claim 27, wherein the adjusting step includes engaging the upper support cylinder with a wrench.

32. The method of claim 27, further comprising mounting a plurality of channeled attachment rails on the upper support at respective points around a circumference of the upper support.

33. A method of installing semiconductor device manufacturing equipment, comprising:
providing an adjustable leg comprising:
an upper support having a first end and a second end, and having an exterior threaded region;
an upper plate coupled to the first end of the upper support;
a lower support having a first end and a second end and having an inner threaded region threadingly coupled to the exterior threaded region of the upper support so that the upper support raises relative to the lower support as the upper support is rotated in a first direction and lowers relative to the lower support as the upper support is rotated in a second direction opposite the first direction; and
a lower plate coupled to the second end of the lower support;
wherein the lower support and the upper support are configured to support semiconductor device manufacturing equipment; and
adjusting a combined length of the lower and upper supports by rotating at least one of the lower support and the upper support.

34. The method of claim 33, further comprising supporting a support frame that is shaped and sized to support semiconductor device manufacturing equipment on the upper plate.

35. The method of claim 34, further comprising supporting semiconductor device manufacturing equipment on the support frame.

36. The method of claim 35, wherein the support frame has a frame outline that substantially duplicates a bottom outline of the semiconductor device manufacturing equipment.

37. The method of claim 33, wherein the adjusting step includes engaging the lower support with a wrench.

38. The method of claim 33, further comprising mounting a plurality of channeled attachment rails on the lower support at respective points around a circumference of the lower support.

39. An adjustable support leg comprising:
a lower support section; and
an upper support section adapted to threadingly couple with the lower support section;
wherein:
the lower and upper support sections are threadingly engaged with each other; and
the lower and upper support sections have dimensions sufficient to provide vertical and lateral support and an engaged portion of the lower and upper support sections includes a number and a dimension of threads sufficient to withstand a shear force generated when the adjustable support leg is employed to support semiconductor device manufacturing equipment.

40. The adjustable support leg of claim 1 wherein the exterior threaded region of the lower support extends at least to the second end of the lower support.

41. The adjustable support leg of claim 9 wherein the exterior threaded region of the upper support extends at least to the second end of the upper support.

42. The support pedestal of claim 17 wherein the exterior threaded region of the lower support of each adjustable support leg extends at least to the second end of the lower support.

43. The adjustable support leg of claim 22 wherein the exterior threaded region of the upper support of each adjustable support leg extends at least to the second end of the upper support.

44. The adjustable support leg of claim 1 wherein at least a portion of the lower support is cylindrically shaped.

45. The adjustable support leg of claim 44 wherein both the upper and lower supports are cylindrically shaped.

46. The adjustable support leg of claim 9 wherein at least a portion of the upper support is cylindrically shaped.

47. The adjustable support leg of claim 46 wherein both the upper and lower supports are cylindrically shaped.

48. The support pedestal of claim 17 wherein at least a portion of the lower support of each adjustable support leg is cylindrically shaped.

49. The support pedestal of claim 48 wherein both the upper and lower supports of each adjustable support leg are cylindrically shaped.

50. The support pedestal of claim 22 wherein at least a portion of the upper support of each adjustable support leg is cylindrically shaped.

51. The support pedestal of claim 50 wherein both the upper and lower supports of each adjustable support leg are cylindrically shaped.

52. The method of claim 27 wherein at least a portion of the lower support is cylindrically shaped.

53. The method of claim 52 wherein both the upper and lower supports are cylindrically shaped.

54. The method of claim 27 further comprising coupling the upper plate to a pedestal support frame.

55. The method of claim 54 wherein the pedestal support frame is configured to allow the upper plate to be coupled thereto at any location along the pedestal support frame.

56. The method of claim 33 further comprising coupling the upper plate to a pedestal support frame.

57. The method of claim 56 wherein the pedestal support frame is configured to allow the upper plate to be coupled thereto at any location along the pedestal support frame.

58. The method of claim 33 wherein at least a portion of the upper support is cylindrically shaped.

59. The method of claim 58 wherein both the upper and lower supports are cylindrically shaped.

60. The adjustable support leg of claim 39 wherein at least a portion of at least one of the lower and upper support sections is cylindrically shaped.

61. The adjustable support leg of claim 60 wherein both the upper and lower support sections are cylindrically shaped.

62. The adjustable support leg of claim 1, further comprising a locking mechanism that compresses the upper support onto the lower support.

63. The adjustable support leg of claim 9, further comprising a locking mechanism that compresses the lower support onto the upper support.

64. The method of claim 27 further comprising compressing the upper support onto the lower support to rotationally lock the two supports relative to one another.

65. The method of claim 33 further comprising compressing the lower support onto the upper support to rotationally lock the two supports relative to one another.
